(19) United States
(12) Patent Application Publication
(10) Pub. No.: US 2026/0084476 A1
(43) Pub. Date: Mar. 26, 2026

(54) HIGH-VOLUME TIRE VALVE

(71) Applicant: THE LEGION ENGINEERING CORPORATION, Changhua City (TW)

(72) Inventor: WAYNE-IAN MOORE, Worcestershire (GB)

(21) Appl. No.: 19/324,606

(22) Filed: Sep. 10, 2025

(30) Foreign Application Priority Data
Sep. 24, 2024 (TW) 113136094

(51) Int. Cl. B60C 29/00; B60C 29/06

(52) U.S. Cl. CPC B60C 29/002; B60C 29/06

(57) ABSTRACT

A high-volume tire valve is provided, wherein the high-volume tire valve includes: a tubular member including a passageway, a shoulder and a necked portion, the passageway including first and second passageways located by two sides of the shoulder, the necked portion being located in the passageway and extending radially inward; a valve core received in the passageway, including a tubular body and an end portion connected to the tubular body, the tubular body defining an axial hole and including at least one lateral hole in communication with the axial hole, an end of the axial hole being open; a seal disposed on the valve core and located in the second passageway, an outer diameter of the seal being greater than a diametric dimension of the first passageway; and a stopper resiliently squeezed into the second passageway and axially blocked by the necked portion.

### BACKGROUND OF THE INVENTION

### Field of the Invention

The present invention relates to a valve, particularly to a high-volume tire valve.

### Description of the Prior Art

A tire valve is mounted on a wheel rim and protrudes from the wheel rim for inflating or deflating a tire. A conventional tire valve mainly includes a valve stem provided in a valve base, and a valve core disposed in the valve stem for controlling the flow or blocking of gas, so that the tire maintains a certain tire pressure.

An upper end of a conventional valve core is provided with a threaded section. A nut is screwed onto the threaded section to pull the valve core tightly against the inner wall of the valve stem to achieve a sealing effect and prevent gas leakage. Furthermore, if the upper end of the valve core is not provided with a threaded section for threading engagement with a nut, the valve core will fall into the interior of the valve and fail to seal. However, the inner diameter of the valve stem has a certain dimension, and the valve core must have a certain wall thickness. Thus, forming a threaded section on the wall of the valve core also restricts the inner diameter of the valve core, thereby significantly reducing the cross-sectional area available for gas flow, which results in lower inflating and deflating volumes.

The present invention is, therefore, arisen to obviate or at least mitigate the above-mentioned disadvantages.

### SUMMARY OF THE INVENTION

The main object of the present invention is to provide a high-volume tire valve that allows for a large gas flow rate, is easy to install, and can effectively maintain sealing.

To achieve the above and other objects, a high-volume tire valve is provided, wherein the high-volume tire valve includes: a tubular member including a passageway, a shoulder and a necked portion, the passageway including a first passageway and a second passageway located by two sides of the shoulder, the necked portion being located in the passageway and extending radially inward; a valve core received in the passageway, including a tubular body and an end portion connected to the tubular body, the tubular body defining an axial hole and including at least one lateral hole in communication with the axial hole, an end of the axial hole being open; a seal disposed on an outer side of the valve core and located in the second passageway, an outer diameter of the seal being greater than a diametric dimension of the first passageway; and a stopper resiliently squeezed into the second passageway and axially blocked by the necked portion.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an exemplary embodiment of the present invention;

FIG. 2 is an exploded view of an exemplary embodiment of the present invention;

FIGS. 3 and 4 are perspective views of the stopper of an exemplary embodiment of the present invention;

FIG. 5 is a radial cross-sectional view of an exemplary embodiment of the present invention;

FIG. 6 is an axial cross-sectional view of an exemplary embodiment of the present invention;

FIGS. 7 and 8 are schematic diagrams of exhausting operation in an exemplary embodiment of the present invention; and

FIG. 9 is an axial cross-sectional view of another exemplary embodiment of the present invention.

### DETAILED DESCRIPTION OF THE PREFERRED EMBODIMENTS

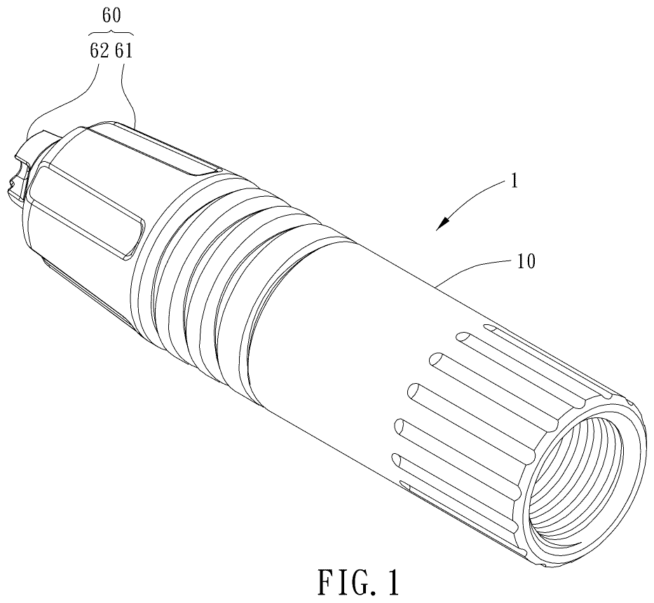

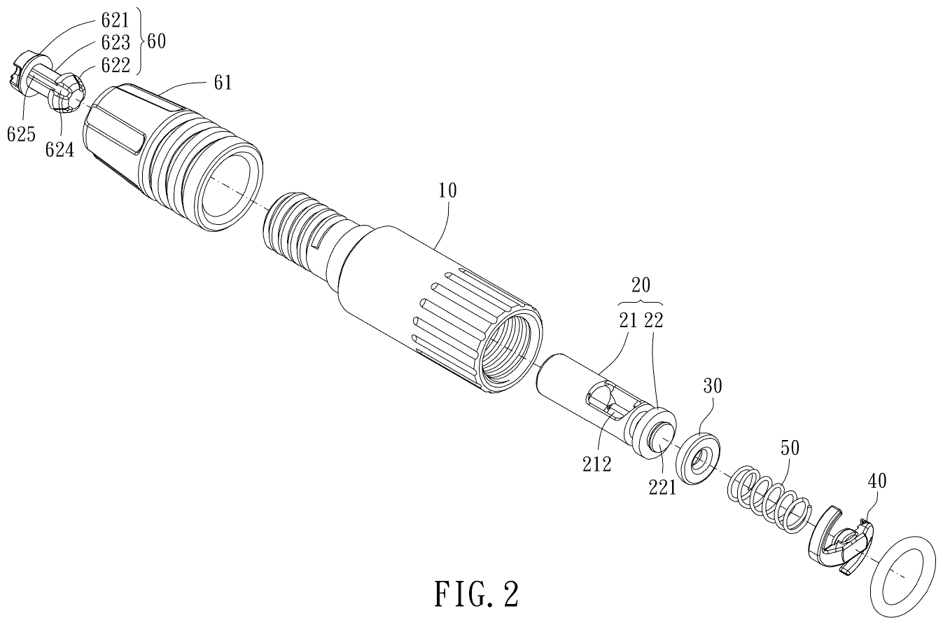

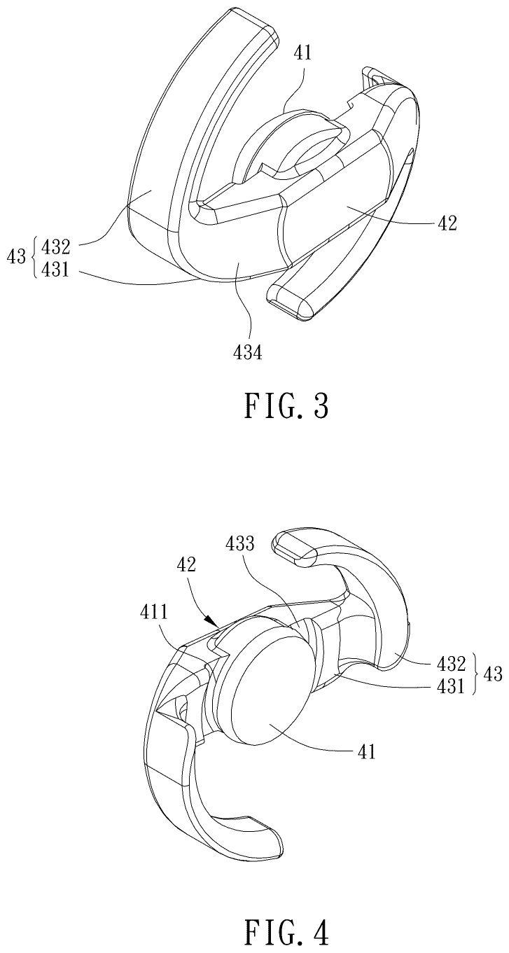

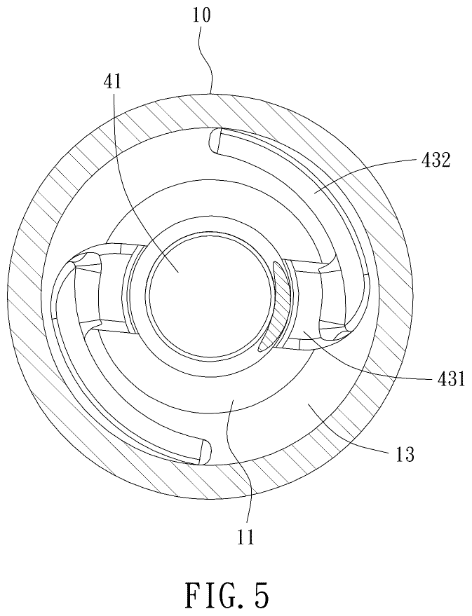

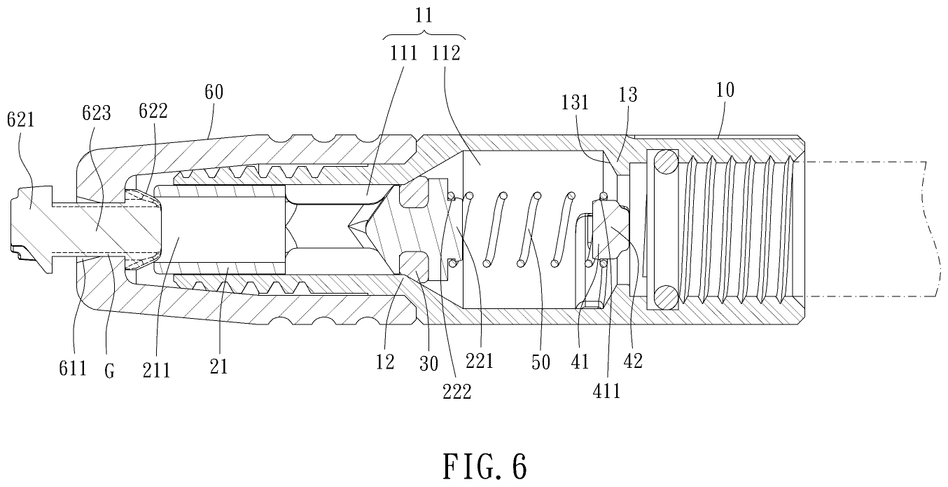

Please refer to FIGS. 1 to 6 for an exemplary embodiment of the present invention. A high-volume tire valve 1 of the present invention includes a tubular member 10, a valve core 20, a seal 30, and a stopper 40.

The tubular member 10 includes a passageway 11, a shoulder 12, and a necked portion 13. The passageway 11 includes a first passageway 111 and a second passageway 112 located by two sides of the shoulder 12. The necked portion 13 is located the passageway 11 (in the second passageway 112, for example) and extends radially inward. A portion of the second passageway 112 in the necked portion 13 may include a tapered section and a straight section. The valve core 20 is received in the passageway 11 and includes a tubular body 21 and an end portion 22 connected to the tubular body 21. The tubular body 21 defines an axial hole 211 and includes at least one lateral hole 212 in communication with the axial hole 211. An end of the axial hole 211 is open. In this embodiment, the tubular body 21 is inserted in the first passageway 111. The seal 30 is disposed on an outer side of the valve core 20 and located in the second passageway 112. The seal 30 is preferably made of elastic material such as rubber or the like. An outer diameter of the seal 30 is greater than a diametric dimension of the first passageway 111. The stopper 40 is resiliently squeezed into the second passageway 112 and axially blocked by the necked portion 13. In this embodiment, the stopper 40 is resiliently squeezed through the necked portion 13 from the second passageway 112.

Preferably, the high-volume tire valve 1 further includes an elastic member 50 is abutted between the end portion 22 of the valve core 20 and the stopper 40 and urges the valve core 20 such that the seal 30 releasably seals against the shoulder 12. The tubular member 10 may be integrally formed of one piece or a multi-component assembly. For example, the tubular member 10 may include a valve body and a valve stem, which may be integrally formed as a one-piece component. The valve body is a portion connected to a rim, and the valve stem is a portion connected to and protruding from the valve body outside the rim. With this structure, a large gas flow rate can be achieved. The stopper 40 is easy to install, the elastic member 50 allows the seal 30 to reliably seal against the shoulder 12, and the valve core 20 will not fall into the tubular member 10, thereby maintaining the sealing engagement between the seal 30 and the shoulder 12 even under insufficient or no air pressure.

Preferably, an outer surface of the valve core 20 is entirely non-threaded, which allows the tubular body 21 of the valve core 20 to retain a required wall thickness while offering a larger inner diameter. This provides good structural strength and a larger gas flow area, facilitating high-flow inflation and deflation. Additionally, the tubular body 21 of the valve core 20 may have a greater axial length (for example, not shorter than the axial length of the first passageway 111 in this embodiment), which allows for larger and/or a plurality of lateral holes 212 to be formed, further increasing gas flow area. In this embodiment, the tubular body 21 of the valve core 20 includes two laterally opposed lateral holes 212, but the number of lateral holes 212 is not limited to two and may be three or more.

The end portion 22 of the valve core 20 includes a first protrusion 221. The elastic member 50 is sleeved on the first protrusion 221. The first protrusion 221 includes a first circumferential groove 222, and a portion of the elastic member 50 is received in the first circumferential groove 222. The stopper 40 includes a second protrusion 41. The elastic member 50 is sleeved on the second protrusion 41. The second protrusion 41 includes a second circumferential groove 411, and a portion of the elastic member 50 is received in the second circumferential groove 411. Thereby, the elastic member 50 is reliably retained and positioned.

In this embodiment, the seal 30 is received on the end portion 22 of the valve core 20 and movable with the valve core 20, and releasably seals against the shoulder 12. However, in other embodiments, the seal may be disposed on an inner surface of the tubular member, and the valve core may move to sealingly abut against or move away from the seal. Preferably, the shoulder 12 and the necked portion 13 are integrally formed on a same tubular section of the tubular member 10. This simplifies manufacturing, improves structural stability and strength, and eliminates the need for additional sealing components, thereby achieving better airtightness.

Specifically, the stopper 40 further includes a base 42 and at least one arm 43. The at least one arm 43 is connected to the base 42 and axially abutted against the necked portion 13. Preferably, the at least one arm 43 is an elastically recoverable structure and is radially deformable to pass over the necked portion 13 and then radially expands to be blocked on one side of the necked portion 13, enabling simple and reliable installation. In this embodiment, the stopper 40 includes two arms 43 connected to two opposite sides of the base 42. The circumferential extensions of the two arms 43 extend in opposite directions, facilitating insertion of the stopper 40 into the tubular member 10. However, the stopper 40 may also include more than two arms. Each of the two arms 43 includes a radial extension 431 and a circumferential extension 432. The radial extension 431 is connected between the base 42 and the circumferential extension 432. The base 42 and the circumferential extension 432 axially protrude from a same side of the radial extension 431. The radial extension 431 provides good support and structural strength, while the circumferential extension 432 provides appropriate elastic deformability. The at least one arm 43 helps center and stably retain the stopper 40.

Specifically, the radial extension 431 includes a recess 433, the recess 433 extends circumferentially along the base 42, and a portion of the elastic member 50 is received in the recess 433. The base 42 includes the second protrusion 41, and the second circumferential groove 411 is in communication with the recess 433. The recess 433 facilitates installation of the elastic member 50 and provides the stopper 40 with excellent elastic deformability. The necked portion 13 includes an inclined blocking surface 131, and each of the two arms 43 further includes an inclined abutting surface 434. The inclined abutting surface 434 extends on the radial extension 431 and the circumferential extension 432 and abuts against the inclined blocking surface 131, thereby stabilizing installation of the stopper 40.

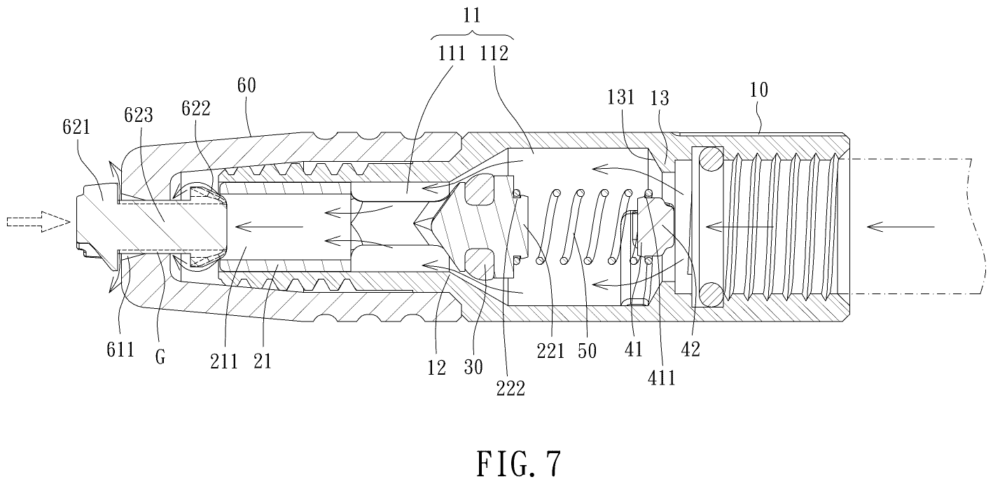

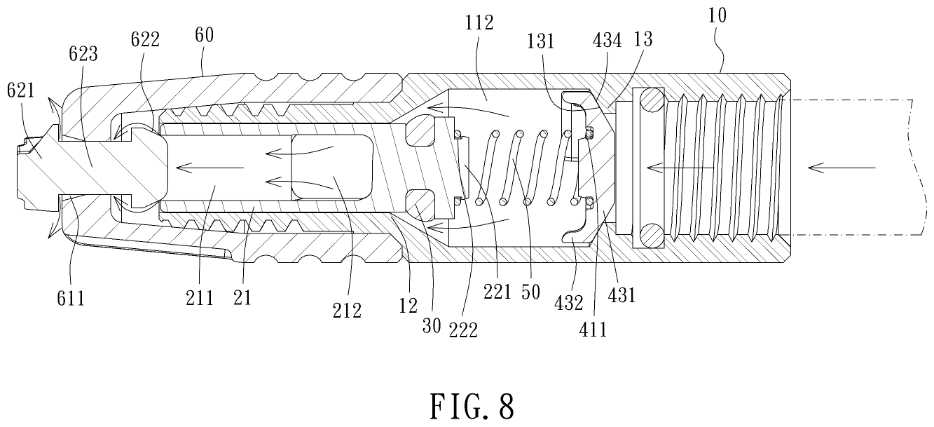

In this embodiment, the high-volume tire valve 1 further includes a cover 60. The cover 60 detachably covers an end of the tubular member 10 and includes a cover body 61 and an insertion member 62. The cover body 61 includes a through hole 611 in gas communication with the passageway 11. The insertion member 62 is axially movably disposed through the through hole 611. At least one gap G is defined between the insertion member 62 and a wall of the through hole 611. The insertion member 62 is in unsealed abutment against the valve core 20. Movement of the insertion member 62 drives the valve core 20 to move, thereby driving the seal 30 to move away from the shoulder 12 (FIGS. 7 and 8). Thus, the tire may be deflated by pressing the insertion member 62 without removing the cover 60, to adjust or fully release the tire pressure.

Specifically, the through hole 611 expands outwardly. The insertion member 62 includes an operation end portion 621, an abutting end portion 622, and a body portion 623 connected between the operation end portion 621 and the abutting end portion 622. The operation end portion 621 and the abutting end portion 622 are located by opposite sides of the through hole 611. The body portion 623 is inserted in the through hole 611. The abutting end portion 622 includes at least one (preferably plural) first air groove 624. The body portion 623 includes at least one (preferably plural) second air groove 625. The at least one second air groove 625 extends through the through hole 611. The at least one first air groove 624 and the at least one second air groove 625 are in gas communication with each other. The abutting end portion 622 abuts against the valve core 20, and the at least one first air groove 624 is in gas communication with the passageway 11. As such, gas may be discharged to the outside through the at least one first air groove 624, the at least one second air groove 625, and the through hole 611.

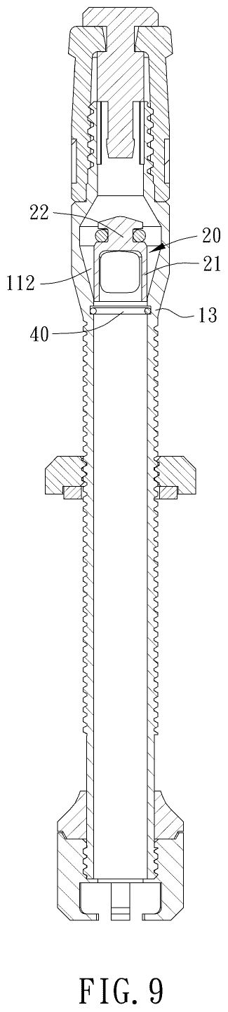

In an alternative embodiment shown in FIG. 9, the tubular body 21 is located in the second passageway 112 and between the end portion 22 of the valve core 20 and the stopper 40, the stopper 40 is radially engaged in the necked portion 13, and the tubular body 21 is movable to be axially blocked by the stopper 40. This structure is simple, and is easy to manufacture and assemble.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A high-volume tire valve including:
a tubular member including a passageway, a shoulder and a necked portion, the passageway including a first passageway and a second passageway located by two sides of the shoulder, the necked portion being located in the passageway and extending radially inward;
a valve core received in the passageway, including a tubular body and an end portion connected to the tubular body, the tubular body defining an axial hole and including at least one lateral hole in communication with the axial hole, an end of the axial hole being open;
a seal disposed on an outer side of the valve core and located in the second passageway, an outer diameter of the seal being greater than a diametric dimension of the first passageway; and
a stopper resiliently squeezed into the second passageway and axially blocked by the necked portion.

2. The high-volume tire valve of claim 1, further including an elastic member abutted between the end portion of the valve core and the stopper and urging the valve core such that the seal releasably seals against the shoulder, wherein the end portion of the valve core includes a first protrusion, the elastic member is sleeved on the first protrusion, the first protrusion includes a first circumferential groove, a portion of the elastic member is received in the first circumferential groove, the stopper includes a second protrusion, the elastic member is sleeved on the second protrusion, the second protrusion includes a second circumferential groove, and a portion of the elastic member is received in the second circumferential groove.

3. The high-volume tire valve of claim 1, wherein the stopper includes a base and at least one arm, and the at least one arm is connected to the base and axially abutted against the necked portion.

4. The high-volume tire valve of claim 3, wherein each of the at least one arm includes a radial extension and a circumferential extension, and the radial extension is connected between the base and the circumferential extension.

5. The high-volume tire valve of claim 4, wherein the base and the circumferential extension axially protrude from a same side of the radial extension.

6. The high-volume tire valve of claim 5, wherein the shoulder and the necked portion are integrally formed on the tubular member; an outer surface of the valve core is entirely non-threaded; the tubular body is inserted in the first passageway; the high-volume tire valve further includes an elastic member abutted between the end portion of the valve core and the stopper and urging the valve core such that the seal releasably seals against the shoulder, the end portion of the valve core includes a first protrusion, the elastic member is sleeved on the first protrusion, the first protrusion includes a first circumferential groove, and a portion of the elastic member is received in the first circumferential groove; the stopper is resiliently squeezed through the necked portion from the second passageway; the stopper includes a second protrusion, the elastic member is sleeved on the second protrusion, the second protrusion includes a second circumferential groove, and a portion of the elastic member is received in the second circumferential groove; the stopper includes two arms, and the two arms are connected to two opposite sides of the base; the circumferential extensions of the two arms extend in opposite directions; the radial extension includes a recess, the recess extends circumferentially along the base, and a portion of the elastic member is received in the recess; the base includes the second protrusion, and the second circumferential groove is in communication with the recess; the necked portion includes an inclined blocking surface, each of the two arms further includes an inclined abutting surface, the inclined abutting surface extends on the radial extension and the circumferential extension and abuts against the inclined blocking surface.

7. The high-volume tire valve of claim 3, wherein the at least one arm is an elastically recoverable structure, and the at least one arm is radially deformable to pass over the necked portion and then radially expands to be blocked on one side of the necked portion.

8. The high-volume tire valve of claim 1, further including a cover detachably covering an end of the tubular member, wherein the cover includes a cover body and an insertion member, the cover body includes a through hole in gas communication with the passageway, the insertion member is axially movably disposed through the through hole, at least one gap is defined between the insertion member and a wall of the through hole, the insertion member is in unsealed abutment against the valve core, and movement of the insertion member is capable of driving the valve core to move to drive the seal to move away from the shoulder.

9. The high-volume tire valve of claim 8, wherein the through hole expands outwardly, the insertion member includes an operation end portion, an abutting end portion, and a body portion connected between the operation end portion and the abutting end portion, the operation end portion and the abutting end portion are located by opposite sides of the through hole, the body portion is inserted in the through hole, the abutting end portion includes at least one first air groove, the body portion includes at least one second air groove, the at least one second air groove extends through the through hole, the abutting end portion abuts against the valve core and the at least one first air groove is in gas communication with the passageway.

10. The high-volume tire valve of claim 9, wherein the at least one first air groove and the at least one second air groove are in gas communication with each other.

11. The high-volume tire valve of claim 1, wherein the tubular body is located in the second passageway and between the end portion of the valve core and the stopper.

12. The high-volume tire valve of claim 11, wherein the stopper is radially engaged in the necked portion.

13. The high-volume tire valve of claim 11, wherein the tubular body is movable to be axially blocked by the stopper.
